(19) United States
(12) Patent Application Publication
(10) Pub. No.: US 2012/0211553 A1
(43) Pub. Date: Aug. 23, 2012

(54) PROCESS FOR THE APPLICATION OF BRILLIANT METALLIC INKS TO PAPER OR PAPERBOARD

(75) Inventor: Patrick Francis Neary, Newport News, VA (US)

(73) Assignee: Shorewood Packaging LLC, Stamford, CT (US)

(21) Appl. No.: 13/438,980

(22) Filed: Apr. 4, 2012

Related U.S. Application Data
(63) Continuation of application No. 13/010,147, filed on Jan. 20, 2011.

(51) Int. Cl. B65D 25/34; B32B 15/12; B05D 1/38; B31B 1/25; B05D 3/02; B05D 3/06; B05D 3/10; B32B 15/02; B05D 5/00

(52) U.S. Cl. 229/116.5; 428/323; 428/207; 427/261; 427/558; 427/552; 427/535; 493/160

(57) ABSTRACT

A process for applying an energy-curable primer and a brilliant metallic ink to a paperboard or paper substrate is provided. The primer may be cured using an energy curing system such as a UV or EB curing system. The curable primer facilitates the orientation of the metallic pigment particles to provide a coherent reflectance of light and optimal reflectance. Advantageously, the primer-cured paper may be “spot-coated” with the metallic ink at pre-designated areas, which minimizes the amount of metallic ink used. In exemplary embodiments, the metallic paper is over-coated with one or more transparent or opaque inks. Additionally, the cured, primer coated paper may be subjected to corona discharge to remove excess solvent and compounds in the liquid phase within the matrix of the cured primer and/or to increase the surface tension of the primer. In certain circumstances, the metallic paper and the end product are recyclable and repulpable.

This application is a continuation of and claims the benefit of U.S. patent application Ser. No. 13/010147, filed Jan. 20, 2011, herein incorporated by reference in its entirety.

### TECHNICAL FIELD AND INDUSTRIAL APPLICABILITY OF THE INVENTION

The present invention relates generally to the papermaking arts, and more particularly, to the application of brilliant metallic inks to a paperboard or paper substrate in a printing press using an energy curing system and an energy-curable primer.

### BACKGROUND OF THE INVENTION

Metallic coated paper is useful in a variety of applications, such as in decorative paper, such as for holiday and gift wrapping paper, pouch papers, for product identification purposes such as in tobacco products or canned food labels, in DVD sleeves, in cosmetic packaging, in lottery tickets, and in packaging for health products such as toothpaste and razors. Metallic coated paper is found to be desirable for such uses because of its glossy aluminized appearance and its related ability to attract the attention of a consumer. Generally, the metallic paper is printed with some sort of product identifier or some type of decorative design and may be made to have varying degrees of gloss level and various performance characteristics. For example, gift wrap and canned food labels must be both easily printable and have a high reflective finish. Other properties include suitable properties for high speed filling and resistance to abrasion and heat on conveying lines where plastic overwraps are used.

Metallic-coated paper is conventionally prepared by a vacuum metallization process in which aluminum is vacuum deposited as a layer onto a substrate. In one process, a solvent-based release layer is applied to a substrate plastic layer (e.g., a polyester layer) and the solvent is evaporated in an oven. Aluminum is vacuum deposited onto the release layer in a vacuum metallizer to form an aluminum layer on the plastic layer. Next, an adhesive is applied to the coated plastic layer, which is subsequently laminated to adhere aluminum layer to a paper. The plastic layer is subsequently removed to provide a laminated metallic-coated paper or packaging material.

In an alternate embodiment, aluminum vapor is vacuum deposited onto a plastic layer (e.g., a polyester layer) having thereon a solvent-based release coating in a vacuum metallizer as described above. The aluminum layer, however, is brushed or otherwise manipulated to release the aluminum from the plastic layer in the form of aluminum flakes as a slurry in a solvent. The slurry may then be processed through sieves and classified for particle size distribution and concentrated by the use of a centrifuge. These aluminum flakes may be collected and added to ink which is applied directly to a paper or paperboard via a conventional printing process.

Although these processes form metallic-coated paper or paperboards, these processes possess numerous disadvantages. For example, conventional laminated metallic-coated paper products are costly and create large volumes of waste that do not break down in landfills. Additionally, the plastic components of these materials are not sustainable, i.e., plastic materials are not obtained from a renewable source and are not easily recyclable. In addition, the solvent-based coating process undesirably involves at least three or four different steps, which increases the process cost and opportunity for manufacturing losses. Moreover, such a process is not optimally energy efficient due to the use of an oven or dryer to evaporate the solvent. Also, the metallic paper produced by applying the aluminum by conventional ink printing processes results in papers having undulated (e.g., irregular) surfaces that prevent a coherent scattering light from the paper, thereby reducing its gloss.

Despite the existence metallic papers and processes for making them, there remains a need in the art for a process for making a metallic-coated paper where the process is economically efficient and where the brilliance of the metallic-coated paper is optimized.

### SUMMARY OF THE INVENTION

It is an object of the present invention to provide a method for forming a brilliant metallic paper or paperboard that include (1) applying an energy-curable primer to a first major surface of a paper or paperboard, (2) curing the energy-curable primer onto the paper or paperboard to form a cured primer layer, (3) applying a metallic ink to the cured primer layer, and (4) drying said metallic ink to form a metallic ink layer. The metallic ink contains a plurality of metallic particles. The energy-curable primer may be cured by passing the paper having thereon the energy-curable primer through an ultraviolet or electron beam curing apparatus. The energy-curable primer facilitates the alignment of said metallic particles in a planar orientation within the metallic ink layer. Such an orientation of the metallic particles minimizes light scattering and maximizes light reflectance to the human eye. Additionally, the energy curable primer and/or the metallic ink may be toned to provide shade and hue differences to said metallic paper or paperboard. In exemplary embodiments, the method may further include applying one or more opaque or transparent inks sequentially onto the metallic ink layer and/or applying a transparent top coat to the metallic ink layer. In addition, the method may include subjecting the cured primer layer to corona discharge prior to applying said metallic ink to the cured primer layer.

It is another object of the present invention to provide metallic paper or paperboard that includes (1) a paper web having on a major surface thereof a coating of an energy-cured primer forming a cured primer layer, and (2) a coating of a metallic ink on the cured primer layer and having therein metallic ink particles. The energy-curable primer facilitates the alignment of the metallic particles in a planar orientation in the metallic ink layer which minimizes light scattering and maximizes light reflectance to the human eye. Such a coordinated reflectance of the metallic particles optimizes the brilliance of the paper or paperboard. In at least one exemplary embodiment, the metallic ink is applied to designated areas of the paper or paperboard to create a design or pattern on the paper. The metallic paper or paperboard may also include a transparent top coat positioned on the metallic ink layer and/or one or more layers of opaque or transparent inks sequentially positioned on the metallic ink layer. Also, in certain circumstances, the metallic paper or paperboard is recyclable and repulpable.

It is a further object of the present invention to provide a carton product that includes (1) a metallic paper substrate or paperboard scored and folded into a box having at least three sides, each side having an external face and an internal face, and (2) an interior portion located within the box for containing a product. The metallic paper is a metallic paper as described in the preceding paragraph. The metallic ink layer may be located on the external and/or internal faces of the box.

It is an advantage of the present invention that the primer coating has an adequate surface tension to facilitate optimized wetting, leveling, and adhesion of the brilliant metallic ink.

It is another advantage of the present invention that the primer coating facilitates the planar orientation of the metallic pigment particles, thereby providing optimal reflectance.

It is yet another advantage of the present invention that the metallic-coated paper or paperboard may be over-printed with transparent or opaque printing inks.

It is a further advantage of the present invention that the metallic ink may be applied in a “spot-wise” fashion to designated areas of the paper or paperboard.

It is another advantage of the present invention that the inventive process can be run at a fraction of the cost of conventional Mylar® printing processes.

It is also advantage of the present invention that the printing process may be conducted in-line or off-line.

It is another advantage of the present invention that the inventive process eliminates the use of plastic required in the prior art processes.

It is a feature of the present invention that a corona discharge device may be implemented to assist in vaporizing excess solvent or chemicals from the treated paper or paperboard.

It is another feature of the present invention that the primer coating is cured by an energy curing system such as UV or EB curing.

It is yet another feature of the present invention that the inventive process uses conventional gravure, flexographic, or tower coating operations.

It is also a feature of the present invention that the energy-curable primer may be toned with pigments and/or dyes to provide apparent solidity or to provide shade and hue differences to the final product.

It is a further feature of the present invention that the metallic ink may be toned with pigments and/or dyes to provide the look or effect of colorized metallic.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of the inventive process for applying an energy-curable primer, metallic ink, and transparent and/or opaque inks in a paper printing process using an externally located energy-curable device to cure the energy-curable primer according to at least one exemplary embodiment of the present invention;

FIG. 2 is a schematic illustration of a metallic paper produced according to at least one exemplary embodiment of the present invention; and

FIG. 3 is a schematic illustration of the inventive process for applying an energy-curable primer, metallic ink, and transparent and/or opaque inks in a paper printing process using an energy-curable device to cure the energy-curable primer and corona discharge to remove excess solvent and compounds from the energy-curable primer according to at least one exemplary embodiment of the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It will be understood that when an element such as a layer, region, substrate, or panel is referred to as being “on” another element, it can be directly on the other element or intervening elements may also be present. Also, when an element is referred to as being “adjacent” to another element, the element may be directly adjacent to the other element or intervening elements may be present. The terms “top”, “bottom”, “side”, and the like are used herein for the purpose of explanation only. Like numbers found throughout the figures denote like elements. As used herein, the terms “paper” and “paper substrate” may be used interchangeably. In addition, the term “primer” and “curable primer” may be interchangeably used herein. Further, the terms “metallic paper”, “metallized paper”, and “metallic-coated paper” may be used interchangeably in this application.

The present invention is directed to a process for the application of brilliant metallic ink to a paperboard or paper substrate (“paper”) having thereon a curable primer coating. The term “paper” as used herein is meant to include all types of cellulose-based products in sheet or web form, including, but not limited to, paper, paperboard, paper substrates, and cardboard. The curable primer orients the metallic pigment particles to provide a coherent reflectance of light and optimal brilliance. The primer may be cured using an energy curing system such as an ultraviolet (UV) or electron beam (EB) curing system. In addition, the inventive process enables the paper to be “spot-coated” with the metallic ink at pre-designated areas, which can minimize the amount of metallic ink used. Additionally, the metallic-coated paper may be over-coated with a transparent or opaque ink. In certain circumstances, the metallic paper and the end product are recyclable and repulpable.

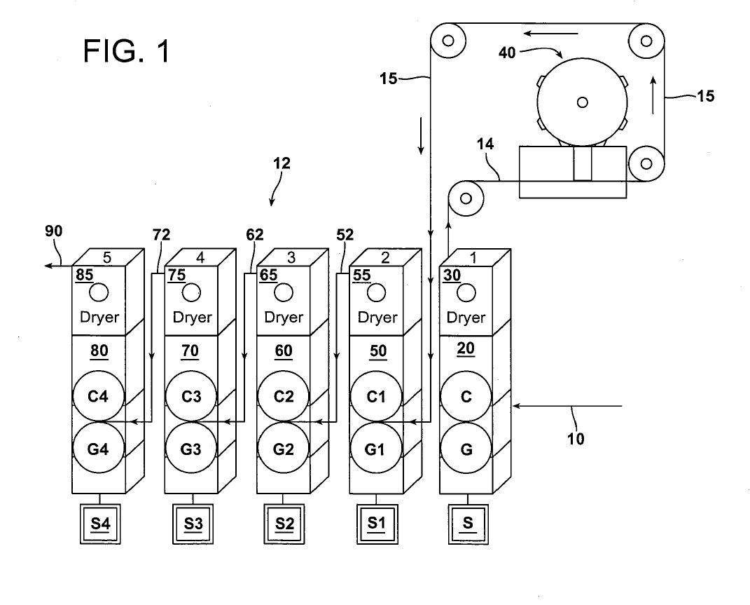

Although any conventional gravure, flexographic, roll coater, curtain coater, tower coating operation or other coating devices may be used in conjunction with the inventive process, for ease of discussion, a gravure process will be discussed herein. Turning to FIG. 1, an exemplary process according the present invention can best be seen. In the process exemplified in FIG. 1, paper 10 is fed into the first print unit 20 of a paper printing apparatus 12 where the energy-curable primer is substantially evenly coated onto a major surface of the paper. As used herein “substantially evenly coated” is meant to denote that the paper is evenly or nearly evenly coated over the surface of the paperboard or paper substrate. In addition, it is desirable that the energy-curable primer be applied to the paper to provide an even, smooth surface that is substantially free of irregularities. It is within the purview of the invention that both major surfaces and/or one or more of the minor surfaces of the paper may be coated with the curable primer. It is also desirable that the paper have as smooth a surface as possible to minimize any undesirable undulations or irregularities that may cause a non-coherent reflectance of the metallic ink. If necessary, an additional primer coating may be used to fill in voids and irregularities of the paper that would otherwise contribute to undesirable absorption and light-scattering which would detract from the finished brilliance of the paper. Additionally, the energy-curable primer may be toned, such as with pigments and/or inks to provide apparent solidity or to provide shade and hue differences to the final product.

Aside from the relative smoothness of the paper, the paper is not particularly limited. The paper may be produced as a single layer or a multi-layer paper having two or more layers. Additionally, the paper may or may not be calendared.

The paper is provided as a web containing cellulosic pulp fibers such as fibers derived from hardwood trees, softwood trees, or a combination of hardwood and softwood trees. The fibers may be prepared for use in a papermaking furnish by any known suitable digestion, refining, and bleaching operations. The paper may optionally contain recycled fibers and/or virgin fibers. It is to be appreciated that recycled fibers differ from virgin fibers in that the recycled fibers have gone through a drying process at least once. In certain embodiments, at least a portion of the fibers may be provided from non-woody herbaceous plants including, but not limited to, kenaf, hemp, jute, flax, sisal, or abaca, although legal restrictions and other considerations may make the utilization of hemp and other fiber sources impractical or even impossible. Additionally, the paper may include conventional additives such as, for example, starch, mineral fillers, sizing agents, retention aids, and strengthening polymers. Among the fillers that may be used are organic and inorganic pigments such as, for example, polymeric particles such as polystyrene latexes and polymethylmethacrylate, and minerals such as calcium carbonate, kaolin, and talc. In some embodiments, the paper may also include hollow microspheres.

Either bleached or unbleached pulp fiber may be utilized. In exemplary embodiments, the source of the cellulosic pulp fibers is from softwood and/or hardwood trees. The cellulosic fibers in the paper may include from about 0% to about 100% or from about 20% to about 80% by weight dry basis softwood fibers and from about 0% to about 100% or from about 20% to about 80% by weight dry basis hardwood fibers.

After the paper 10 has been coated with the energy-curable primer, such as by impression cylinder “C” and engraved gravure cylinder “G” in the first print unit 20, the coated paper 14 bypasses the dryer 30 in the first print unit 20 (not depicted) and proceeds to the energy curing device 40 located external to the paper printing process 12. It is to be appreciated that in some exemplary printing units, the dryer 30 may be removed from the first print unit 20. The energy curing device 40 cures the primer onto the paper 10 forming a cured primer layer. Non-limiting examples of suitable energy curing apparatuses include UV (ultraviolet) curing and EB (electron beam) curing. The energy-curable primer facilitates the orientation of the metallic particles in a planar fashion on the paper 10 so that a coherent reflectance off of the particles is achieved and optimized brilliance is obtained. “Brilliance”, as used herein, is meant to denote the high brightness or shine of light reflecting from the surface of the paper. As discussed in detail below, a coherent reflection off the metallic particles 45 causes minimal light scattering, thereby directing more light to the human eye and creating a more brilliant paper.

The primer may be any suitable primer that can be energy cured and which has sufficient surface tension to facilitate optimized wetting, leveling, and adhesion of the brilliant metallic ink to the paper 10. In addition, the primer should be applied at a sufficiently low and Newtonian viscosity so that it provides a level surface after printing and curing. Surfactants may be used in the primer formulation to facilitate leveling. Both the UV and EB curable primers include energy activated monomers and oligomers as well as various optional modifiers including waxes, anti-foaming agents, defoamers, etc. to adjust surface slip and surface tension. In UV primer coatings, a photo-initiator is used to promote cross-linking or photo-polymerization when the monomers or oligomers are exposed to UV energy from the energy curing device 40. Such photo-polymerization causes crosslinking of the monomers and/or oligomers and turns the applied liquid coating to a uniform, plastic-like solid.

Additionally, nitrogen may be used to blanket the applied coating during the curing process to minimize the amount of oxygen present in the system because oxygen may have an inhibitory effect on the energy-curing process. Also, the viscosity of the primer may be further reduced at press-side by inputting thermal energy into the coating supply sump “S”. Alternatively (or additionally), thermal energy may be added by heating the coating within the circulating energy coating system 40. Other energy inputs such as ultrasonic energy (not shown) may also be utilized to facilitate coating and ink flow-out/leveling either prior to or subsequent to the coated paper 14 passing through the energy curing device 40. Heat from print unit dryers 50, 65, 75, 85 can also be used to warm the paper and may therefore facilitate improved coating flow-out and leveling of the primer. Non-limiting examples of suitable primers for use in conjunction with the inventive process include ProCure EB primer coating (commercially available from Inx International) and Suncure (commercially available from Sun Chemical).

The energy-curable primer is applied to the paper 10 in an amount sufficient to achieve a planar orientation of the metallic particles in the metallic ink. Although not wishing to be bound by theory, it is believed that the primer coating application volume should be optimized in to facilitate essentially Newtonian coating flow and applied coating film smoothness. Specifically, it is believed that that the primer coating must be optimized to aid in the Newtonian rheology or pre-cured flow of the energy-curable primer coating for best visual/optical brilliance results.

The cured, primer-coated paper 15 is returned to the printing apparatus 12 at the second print unit 50 where the metallic ink is applied to the coated surface of the paper 15. The metallic ink used in the inventive process and paper is not particularly limited, and may include metallic inks having colors such as silver, gold, and bronze. Non-limiting examples of metallic inks for use in the present invention include metallic inks manufactured by Inx International, Flint Group, and Sun Chemical.

The metallic ink may be applied on the cured primer on the major surface of the paper 15 such as by impression cylinder “C1” and engraved gravure cylinder “G1” within the second print unit 50. In addition, the metallic ink may be toned with pigments and/or dyes to provide the look or effect of colorized metallic. The water-based metallic ink may be applied to the coated paper 12 from the gravure cylinder “G1” in an amount from about 0.3 pounds per thousand square feet to about 3.0 pounds per thousand square feet of printed and coated paper. The particles within the metallic ink essentially flatten out (e.g., are aligned to be parallel or substantially parallel to the paper and coated surface) in the metallic ink positioned on the cured primer.

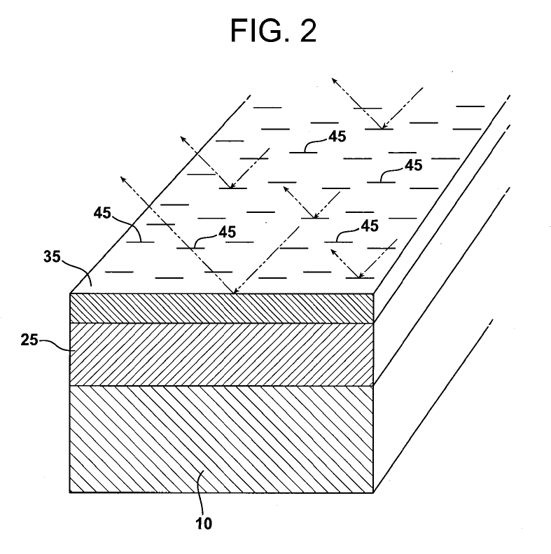

As illustrated in FIG. 2, a paperboard or paper substrate 10 coated with a cured primer layer 25 and a metallic ink layer 35 has a coherent reflection off of the metallic particles 45, resulting in optimal brilliance. Specifically, there is minimal light scattering off the metallic particles 45 and more light directed to the human eye or other optical receiver. A failure to planarly align the metallic particles 45 in the metallic ink layer 35 results in random light scattering off the metallic particles and a greatly reduced potential for the reflected light to be received by the human eye (or other optical receiver). As a result, such randomly aligned metallic ink particles create a metallic paper that appears dull or less brilliant. In contrast, directed light (e.g., light that is coherently reflected from the metallic particles) creates a paper that has increased brilliance by reflecting the light in a non-random fashion, such as depicted in FIG. 2, that can easily be seen.

Additionally, it is to be understood that the energy-curable primer and the metallic ink may be applied to specific, desired areas on the paper. Such “spot-coating” enables a design or pattern (e.g., a logo) to be created on the paper. As one example, the metallic ink may be applied to predetermined areas of the cured primer layer to form designs or logos on the cured primer layer (and thus the paper). In addition, by applying the metallic ink to specific portions of the paper, less metallic ink is needed, particularly when compared to an embodiment where the entire paper is coated with the metallic ink. The use of less primer and/or less of the relatively costly metallic ink correlates to a reduction in manufacturing and product costs.

Turning back to FIG. 1, once the metallic ink is applied, the paper is passed through the dryer 55 in the second print unit 50 to dry the metallic ink on the cured primer. In at least one exemplary embodiment, the metallic paper 52 may be fed through one or more additional print units to apply various other colored inks, either opaque or transparent. This additional printing over the metallic ink permits for the creation of designs or labels onto the metallic paper 52. FIG. 1 depicts the subsequent application of three separate colors onto the metallic paper 52 by third, fourth, and fifth print units 60, 70, 80. For example, the metallic paper 52 may be fed from the dryer 55 into the third print unit 60 where a first color (e.g., green) is applied to the paper 52 such as via impression cylinder “C2” and gravure cylinder “G2”. This color coated paper 62 is then passed through the dryer 65 in the third tower 60 and into the fourth print unit 70 where a second color (e.g., red) is applied to the paper such as by impression cylinder “C3” and gravure cylinder “G3”. This paper may then be transferred or conveyed to the dryer 75 in the fourth print unit 70 to dry the second color. The two-colored paper 72 may then be passed into the fifth tower 80 where a third color (e.g. blue) is applied such as via impression cylinder “C4” and gravure cylinder “G4”. A third color is dried in the dryer 85 in the third tower 80. Preferably, the paper is dried in the dryers 65, 75, and 85 to contain less than or equal to 10% water. The color-enhanced metallic paper 90 may optionally be sent for additional processing such as calendaring, embossing, debossing, hot foil stamping, cold foil stamping, as well as any other conventional processing steps.

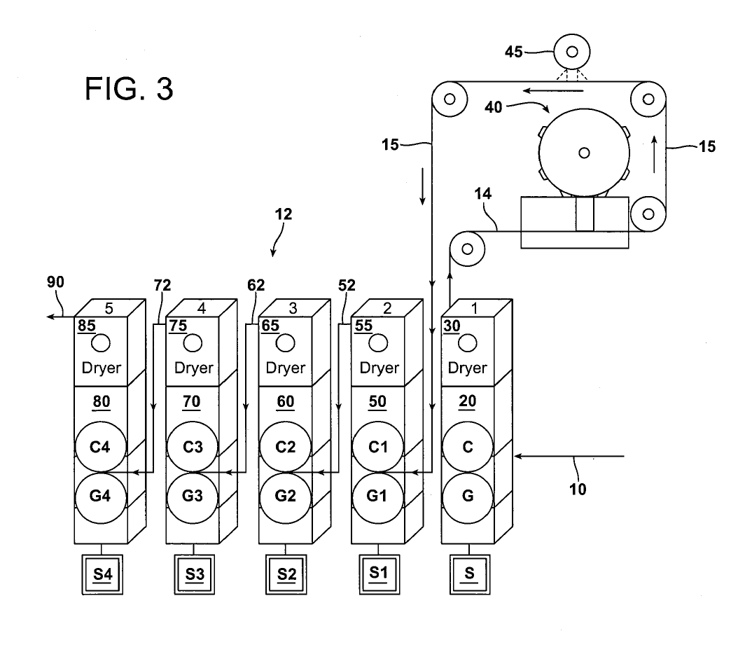

It is to be understood that additional print units (or fewer print units) than those depicted in FIG. 1 (and FIG. 3) may be employed to apply one or more opaque or transparent ink(s) to achieve a desired appearance on the metallic paper. In addition, the colors are not meant to be restricted to red, green, and blue, as any color or combination of colors may be applied to the metallic paper 55, including process colors for photo-like imaging. The colors within the print units may be any color desired to achieve the specified appearance on the paper. The colors may be applied in a manner so as to form a logo, photo reproduction, or other mark identifiable by consumers of a particular product, such as a folding carton product for a tobacco product. For instance, the metallic paper may be scored and folded into a box-like shape having at least three sides (e.g., substantially triangular, rectangular, square, hexagonal, etc.) with the metallic surface positioned either inwardly or outwardly. As one example, the metallic paper may be scored and folded into a carton having at least four sides and an interior portion for containing a product. In an alternate embodiment, the metallic paper may be formed and/or shaped into an “O-card”, hanger card, or other packaging suitable for retail display. Also, the paper may be used on cylindrical containers for packaging various products.

Alternatively, the metallic paper 55 may not pass through such additional printing towers (not illustrated) and retain a non-colored brilliant metallic ink surface. In such an instance, the metallic paper 55 may be sheeted and transferred for additional processing after it emerges from the dryer 50. It is to be appreciated that subsequent steps, such as, but not including applying a final coating to the paper, cutting the continuous coated paper into desired lengths, scoring, and folding the scored blanks into cartons, although not illustrated for purposes of simplicity, are considered within the purview of the invention.

It is also to be understood that FIGS. 1 and 3, which depict the energy-curable primer being applied to the paper 10 in the first print unit 20 and the metallic ink being applied to the primer-coated paper 15 in the second print unit 50, depict only one exemplary embodiment of applying the energy-curable primer and metallic ink. Indeed, the energy-curable primer may be applied to the paper by any print unit in the paper printing apparatus 12. In addition, the metallic ink may be applied by any print unit in the paper printing apparatus 12 located downstream (subsequent to) the print unit that applies the energy-curable primer. As with the embodiments described above, the energy-curable primer is cured in an energy curing device after its application to the paper. Additionally, opaque and/or transparent inks (e.g., the colored inks described above) may be applied at any point in the paper printing apparatus 12. For example, opaque and/or transparent inks may be applied prior to and/or after the application of the energy-curable primer and/or the metallic ink. Further, opaque and/or transparent inks may be applied between the application of the energy-curable primer and metallic ink.

The color-enhanced metallic paper 90 or non-colored metallic paper 55 may further be at least partially coated with at least one transparent top coating layer (not shown). The top coating layer may be applied to the surface of the metallic ink in the metallic paper 55 or to the surface of the color layer(s) formed on the metallic ink in the color-enhanced metallic paper 90. The coating layer may contain a binder and optionally a pigment. The coating provides additional abrasion resistance and/or slip, apparent depth, and/or gloss to the finished product. Wax and/or other particles contained within the coating(s) may cause light-scattering which could diminish the apparent brilliance of the finished product. Therefore, it may be necessary to use particulate-free slip and anti-abrasion compounds that are soluble in the system to prevent undesirable random light-scattering. Other ingredients of the coating layer may include surfactants, dispersion aids, and other additives conventionally used in printing compositions. Such a top coating layer may provide a protective layer and/or enhance the brilliance and gloss of the metallic ink forming the metallic ink layer 35 (see FIG. 2).

In at least one exemplary embodiment, depicted in FIG. 3, the cured, primer coated paper 15 is subjected to corona discharge by a corona discharge apparatus 45 prior to entering the second print unit 50. The corona discharge effectively removes compounds and excess solvent in the liquid phase within the matrix of the cured primer that may remain after curing the primer onto the paper 10. Additionally, the corona discharge system can be used to increase the surface tension of the primer, resulting in a surface that wets more efficiently with consecutively applied inks and coating films and further results in an improved adhesion of those inks and coating films. The remainder of the process depicted in FIG. 3 remains the same as described in detail above with respect to FIG. 1, and as such, will not be discussed with respect to this embodiment.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A method of forming a brilliant metallic coated paper material comprising:
applying a substantially level layer of energy-curable primer coating to a first major surface of the paper material;
curing the layer of energy-curable primer to create an ink receptive and substantially inactive interface layer, a top surface of the inactive interface layer having a relatively high surface tension;
applying a reflective metallic ink to at least a portion of the cured primer layer, such that the metallic ink has lower surface tension than the top surface of the inactive interface layer, and includes a plurality of reflective metallic particles and deposited in a substantially planar orientation; and
drying the metallic ink to form a metallic ink layer on the cured primer.

2. A method as in claim 1, wherein the applying comprises applying the primer directly to a first major surface of the paper material.

3. A method as in claim 1, wherein the applying comprises applying the primer to an intermediate layer already present on the first major surface of the paper material.

4. A method as in claim 1, further comprising applying one or more opaque or transparent inks sequentially onto said metallic ink layer.

5. The method of claim 1, further comprising applying a transparent top coat to said metallic ink layer.

6. The method of claim 1, wherein said curing comprises irradiating the energy-curable primer with an ultraviolet or electron beam curing apparatus.

7. The method of claim 1, wherein at least one of said energy curable primer and said metallic ink is toned.

8. The method of claim 1, further comprising subjecting said cured primer layer to corona discharge prior to applying said metallic ink to said cured primer layer.

9. The method of claim 1, wherein said energy-curable primer is applied to said paper in a print unit in a paper printing apparatus,
wherein said metallic ink is applied to said cured primer layer in a subsequent print unit in said paper printing apparatus, and
wherein said curing occurs externally to said paper printing apparatus.

10. The method of claim 1, wherein said paper material comprises a material selected from the group consisting of paper and paperboard.

11. The method of claim 1, further comprising:
cutting the coated paper material to form blanks;
scoring the blanks; and
folding the scored blanks to form a package.

12. A metallic paper or paperboard comprising:
a paper web having on a major surface thereof a coating of a cured primer forming a cured primer layer; and
a coating of a metallic ink having therein metallic ink particles, said metallic ink being positioned on said cured primer layer and forming a metallic ink layer, the particles being in a substantially planar orientation.

13. The metallic paper or paperboard of claim 12, wherein said orientation of said metallic particles minimizes light scattering and maximizes light reflectance to the human eye.

14. The metallic paper or paperboard of claim 12, further comprising a transparent top coat positioned on said metallic ink layer.

15. The metallic paper or paperboard of claim 12, further comprising one or more layers of opaque or transparent inks sequentially positioned on said metallic ink layer.

16. The metallic paper or paperboard of claim 12, wherein said metallic ink is located on designated portions of said cured primer layer so as to form a predetermined design or logo on said cured primer layer.

17. A carton product comprising:
a metallic paper substrate or paperboard scored and folded into a box having at least three sides, each said side having an external face and an internal face; and
an interior portion located within said box for containing a product,
wherein said metallic paper comprises:
a paper web having on a major surface thereof a coating of an energy-cured primer forming a cured primer layer; and
a coating of a metallic ink having therein metallic ink particles, said metallic ink being positioned on said cured primer layer and forming a metallic ink layer, the particles being in a substantially planar orientation, and
wherein said metallic ink layer is located on one or both of said external faces and said internal faces.

18. The carton product of claim 17, wherein an ink layer underlies the primer layer.

19. The carton product of claim 17, further comprising a transparent top coat positioned on said metallic ink layer.

20. The carton product of claim 17, further comprising one or more layers of opaque or transparent inks sequentially positioned on said metallic ink layer.
